(19) United States
(12) Patent Application Publication
(10) Pub. No.: US 2025/0274940 A1
(43) Pub. Date: Aug. 28, 2025

(54) SYSTEMS AND METHODS OF MULTI-PANEL SIMULTANEOUS PHYSICAL UPLINK SHARED CHANNEL TRANSMISSIONS

(71) Applicant: APPLE INC., Cupertino, CA (US)

(72) Inventors: Seyed Ali Akbar Fakoorian, San Diego, CA (US); Weidong Yang, San Diego, CA (US); Yushu Zhang, Beijing (CN); Hong He, San Jose, CA (US); Dawei Zhang, Saratoga, CA (US); Haitong Sun, Cupertino, CA (US); Sigen Ye, San Diego, CA (US); Wei Zeng, San Diego, CA (US)

(21) Appl. No.: 18/858,582

(22) PCT Filed: Jan. 23, 2023
(86) PCT No.: PCT/US2023/061066

§ 371 Date: Oct. 21, 2024

Related U.S. Application Data
(60) Provisional application No. 63/363,792, filed on Apr. 28, 2022.

(51) Int. Cl. H04W 72/21; H04B 7/06

(52) U.S. Cl. CPC H04W 72/21; H04B 7/0639; H04B 7/06966

(57) ABSTRACT

Systems and methods for the use of multiple-antenna-panel simultaneous physical uplink shared channel (PUSCH) transmissions are disclosed herein. A sounding reference signal (SRS) resource set indicator corresponding to a pair of SRS resource set may be provided by a network to a user equipment (UE), where the pair of SRS resource sets includes a first SRS resource set for a first PUSCH on a first antenna panel of the UE and a second SRS resource set for a second PUSCH on a second antenna panel of the UE. The UE may also receive, from the network, a pair of SRS resource indicators (SRIs). The UE may match each of the SRIs to one of the SRS resource sets based on the SRS resource set indicator. The multi-panel simultaneous PUSCHs are then transmitted on the antenna panels according to the matching of the SRS resource sets to the SRIs.

### TECHNICAL FIELD

This application relates generally to wireless communication systems, including single downlink control information (s-DCI), multi-panel physical uplink shared channel (PUSCH) transmissions, and antenna virtualization and precoding.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and Institute of Electrical and Electronics Engineers (IEEE) 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of MPSTx according to certain embodiments.

FIG. 2A and FIG. 2B illustrate UL beam indication for FDM according to certain embodiments.

FIG. 3A, FIG. 3B, and FIG. 3C illustrate example DMRS tables used to indicate the associated port index to the antenna panel with smaller number of layers according to certain embodiments.

FIG. 4 illustrates a method of a UE, according to embodiments herein

FIG. 5 illustrates a method of a UE, according to embodiments herein.

FIG. 6 illustrates a method of a RAN, according to embodiments herein.

FIG. 7 illustrates an example architecture of a wireless communication system, according to embodiments disclosed herein.

FIG. 8 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Abbreviations of some terms/concepts used herein are as follows:
Single Downlink Control Information (DCI) (s-DCI)
Multiple Downlink Control Information (m-DCI)
Multi-Panel Simultaneous Transmission (MPSTx)
Multi-Panel Simultaneous Transmission with Spatial Domain Multiplexing (sdmMPTx)
Multi Panel Simultaneous Transmission with Frequency Domain Multiplexing (fdmMPTx)
One Shot (no repetition transmission of a single transport block (TB)) with Multi-Panel Simultaneous Transmission (1sMPTx)
Repetition (in frequency and/or space of a single TB) with Multi-Panel Simultaneous Transmission (ReMPTx)

In 3GPP New Radio (NR) Release 16 (R16), simultaneous physical downlink shared channel (PDSCH) reception(s) corresponding to multiple transmission reception point (TRP) (m-TRP) use cases were specified. If scheduled by s-DCI, PDSCH resources associated to different downlink (DL) beams (e.g., different spatial receive (Rx) filters) are frequency division multiplexed (FDMed). For example (see, e.g., 3GPP Technical Specification (TS) 38.214, version 17.1.0 (2022-03), Section 5.1), a UE may be indicated with two transmission configuration indicator (TCI) states in a codepoint of the DCI field ‘Transmission Configuration Indication’ and demodulation reference signal (DM-RS) port(s) within one code division multiplexing (CDM) group in the DCI field ‘Antenna Port(s)’. When the UE is set to ‘fdmSchemeA’, the UE receives a single PDSCH transmission occasion of the transport block (TB) with each TCI state associated to a non-overlapping frequency domain resource allocation. When the UE is set to ‘fdmSchemeB’, the UE receives two PDSCH transmission occasions of the same TB with each TCI state associated to a PDSCH transmission occasion which has non-overlapping frequency domain resource allocation.

If scheduled by m-DCI, two PDSCH receptions can be fully/partially/non-overlapped PDSCHs in the time and frequency domains. Physical downlink control channels (PDCCHs) that schedule two PDSCHs may be associated to different ControlResourceSets having different values of coresetPoolIndex.

In NR Release 17 (Rel-17), a UE can transmit multiple repetitions of the same TB across different UL beams, where repetitions are time division multiplexed (TDMed). The beam indication is through extending a sounding reference signal (SRS) resource indicator (SRI) bit field, when two SRS resource sets with usage as codebook (CB) (or two SRS resource sets with usage as non-codebook) are configured. All repetitions have the same rank (number of layers), although repetitions over different beams may have different antenna ports, different transmit precoder matrix indicators (TPMIs) (for CB based transmission), transmit power control (TPC), etc.

In NR Release 16 (Rel-16) or Rel-17, simultaneous PUSCH transmission is not supported (e.g., is not supported for either the spatial division multiplexing (SDM) case nor the FDM case).

Accordingly, it may be beneficial to specify the use of simultaneous multi-panel UL transmission. This may include, for example, the specification of a UL precoding indication for PUSCH, considering single DCI and multi-DCI based multi-TRP operation. This may further include the specification of a UL beam indication for physical uplink control channel (PUCCH)/PUSCH, considering both s-DCI and m-DCI based multi-TRP operation.

There are presently outstanding issues related to the case of s-DCI based multi-panel simultaneous PUSCH transmissions. A first issue involves the application of resource allocation in the frequency and/or spatial domains for the following cases: A first case involving a single PUSCH occasion across different antenna panels; a second case involving repetition of the same TB across different antenna panels; and a third case involving simultaneous PUSCH transmission of two TBs (two codewords).

A second issue involves the manner of indicating UL beams for transmissions across different antenna panels. Applicable considerations related to this issue may include factors like signaling overhead, the flexibility of the beam indication, cross antenna panel interference (e.g., depending on resource allocation scheme as discussed above in relation to the first issue), a number of layers per antenna panel, a DM-RS/antenna port indication, and/or a precoding indication across different simultaneous transmission (in the case of CB based transmission).

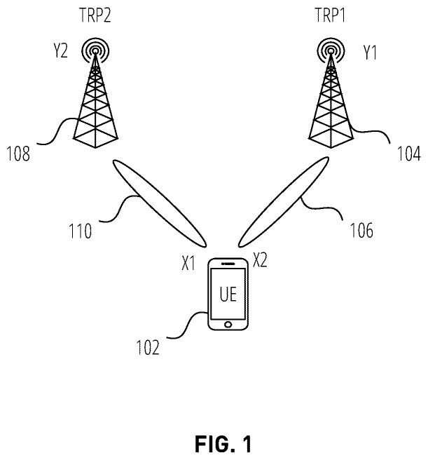

FIG. 1 illustrates an example of MPSTx according to certain embodiments. In this example, a UE 102 communicates with a TRP1 104 using a UL beam 106 indicated by a first SRS resource set and with a TRP2 108 using a UL beam 110 indicated by a second SRS resource set. Note that in FDM, there may be no inter-antenna-panel interference at each TRP. Here,
and

$${Y}_{2} = {H}_{2} {X}_{2} + {G}_{2} {X}_{1} + {Z}_{2} = [ {G}_{2} {H}_{2} ] [ \begin{matrix}{X}_{1} \\ {X}_{2}\end{matrix} ] + {Z}_{2} .$$

### Embodiments of Beam Indications for MPSTx

Under a first proposal for beam indications for MPSTx, for s-DCI, and in at least the case of FDM resource allocation of multi-panel simultaneous PUSCH transmissions, the following procedures to indicate the UL beams to use for simultaneous PUSCH transmissions may be used.

First, a UE may be configured to use fdmMPTx, and may be further configured with two SRS resource sets (with usage of value ‘nonCodeBook’ when txConfig=‘nonCodeBook,’ or with usage of value ‘CodeBook’ when txConfig=‘CodeBook’). It may be that each SRS resource set is solely associated to one antenna panel. In such circumstances, an SRS resource set indicator bit-field may indicate the use of both SRS resource sets with either codepoint “10” (indicating that the first and second SRS resource sets are respectively applied to the first and second PUSCH) or codepoint “11” (indicating the second and first SRS resource sets are respectively applied to the second and first PUSCH). Under the first proposal, the two PUSCHs each carry a same number of layers as indicated by the SRS resource set associated to the SRI in the first SRI bit-field (for nonCodeBook cases) and the TPMI in the first TPMI bit-field (for CB cases).

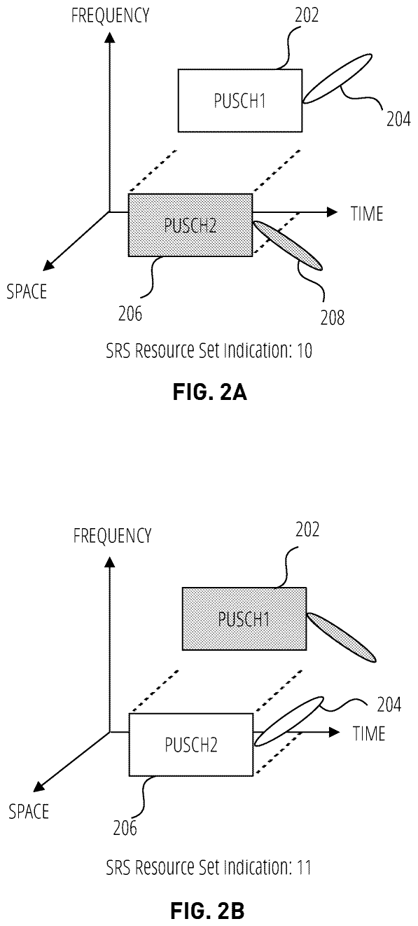

For example, FIG. 2A and FIG. 2B illustrate contrasting results of different UL beam indications for FDM according to certain embodiments.

In FIG. 2A, the SRS resource set indicator indicated to the UE is “10.” Accordingly, PUSCH1 202 is transmitted using a UL beam 204 indicated by a first SRS resource set, and PUSCH2 206 is transmitted by UL beam 208 indicated by a second SRS resource set.

In FIG. 2B, the SRS resource set indicator indicated to the UE is instead “11.” In this example, the PUSCH1 202 is accordingly transmitted using the UL beam 208 indicated by the second SRS resource set while the PUSCH2 206 is transmitted by the UL beam 204 indicated by the first SRS resource set.

Note that while in FIG. 2A and FIG. 2B illustrate that the PUSCH1 202 and the PUSCH2 206 are in separate spatial layers/domains, this is not strictly required under the first proposal.

In such cases, codepoint “00” or “01” for the SRS resource set indicator indicates to the UE no simultaneous PUSCH transmission occurs. In such cases, if the UE is configured with fdmMPTx, it will transmit both PUSCH1 202 & PUSCH2 206 over antenna panel 0 (corresponding to the 1st SRS resource set). Further, in such cases, if UE is configured with sdmMPTx, the UE will transmit only PUSCH1 202 over antenna panel 0 (corresponding to the 1st SRS resource set). Alternatively, the case where the UE is configured with sdmMPTx may be instead considered an error case.

Under the first proposal, each SRS resource set is associated with each indicated joint or uplink (UL) TCI for PUSCH beam indication in the s-DCI. In some embodiments, it may be that, only one of the first or second SRS resource set is valid for PUSCH scheduling.

Potential limits of the procedures of the first proposal may be as follows. First, while this methodology accounts for FDM aspects, it may not explicitly capture inter-panel interference aspect that may arise in the case of SDM. Second, there may be no manner of causing to use a different number of layers for PUSCH transmissions occurring on different panels

Under a second proposal for beam indications for MPSTx, for s-DCI, and in at least the case of multi-TB (i.e., two contention windows (CWs)) multi-panel simultaneous PUSCH transmissions, the following procedures to indicate the UL beams to use for simultaneous PUSCH transmissions may be used.

Initially, note that under the second proposal, the UE may be configured with fdmMPTx or sdmMPTx. Similarly to the first proposal, it may be that there are two SRS resource sets (with usage of value ‘nonCodeBook’ when txConfig=‘nonCodeBook’ or with usage of value ‘CodeBook’ when txConfig=‘CodeBook’). Further, an SRS resource set indicator bit-field may indicate the use of both SRS resource sets with either codepoint “10” (indicating that the first and second SRS resource sets are respectively applied to the first and second PUSCH) or codepoint “11” (indicating the second and first SRS resource sets are respectively applied to the second and first PUSCH).

However, from this point, the second proposal may differ from and/or expand upon the first proposal according to one of a number of options. Under a first such option, for the case of txConfig=‘nonCodeBook,’ the second SRI bit field may be understood to assume/allow for all possible ranks for the corresponding SRS resource set (similarly to the first SRI bit-field), without dependency on the rank corresponding to the first SRI. In such cases, this this change may increase DCI size by up to 1 bit.

Further under the first such option, for the case of txConfig=‘CodeBook,’ the second TPMI bit-field may be understood to indicate/allow for all possible number of layers for the corresponding beam/antenna panel. This may increase DCI size by up to 1 bit in some cases, or up to 2 bits for the case of 4 antenna ports, a disabled transform precoder, maxRank set to 3 or 4, ul-FullPowerTransmission set to fullpowerModel, and codebookSubset set to “partialAndNonCoherent.”

A second option according to the second proposal for differing from the first proposal may be like/build upon the first option according to the second proposal as just described. However, under the second option, it may be that the UE indicates to the a maximum number of layers per antenna panel for multiple-panel (MP) simultaneous PUSCHs. In such cases, a maximum rank for each antenna panel (e.g., a maximum rank for a PUSCH associated with each SRS resource set) can be configured by radio resource control (RRC) signaling. For example, an indication in the format (a,b) may be made, where a is the maximum rank of the first antenna panel and b is the maximum rank of the second antenna panel. For example, (1,1), (2,1), (1,2), (2,2) may be understood as examples of (a,b) indications that may be used. Note that in an (a,b) indication, neither a nor b can be larger than Lₘₐₓ, which is understood to be the maximum number of layers useable by the UE (e.g., whether configured or inherently to the UE).

For the case of txConfig=‘nonCodeBook,’ the size of first and second SRI bit fields are determined accordingly, by taking into account number of SRS resources associated to the first and second SRI bit field. This may be done using the formula

$$f ( {N}_{SRS} , {L}_{max} ) = \vert {log}_{2} ( {\sum }_{k = 1}^{min ( {L}_{max} , {N}_{SRS} )} ( \begin{matrix}{N}_{SRS} \\ k\end{matrix} ) ) \vert$$

where N_{SRS} is understood to be the number of configured SRS resource in the SRS resource set and Lₘₐₓ is the maximum number of layers useable by the UE (e.g., whether configured or inherently to the UE).

For example, for UE capability (2,1), assume that N_{SRS,1} and N_{SRS,2} represent a number of SRS resources in each of the first and second SRS resource sets, respectively. Then, if the SRS resource set indicator is “10” (corresponding to a case where the first SRS resource set matches to the first SRI field and the second SRS resource set matches to the second SRI field), the first and second SRI bit-fields have respectively f(N_{SRS,1}, 2) and f(N_{SRS,2}, 1) bits.

Alternatively, if SRS resource set indicator is “11” (corresponding to a case where the first SRS resource set matches to the second SRI field and the second SRS resource set matches to 1st SRI field), the first and second SRI bit-fields have respectively f(N_{SRS,2}, 2) and f(N_{SRS,1}, 1) bits.

Under a third proposal for beam indications for MPSTx, for s-DCI, and at least for SDMed multi-panel simultaneous PUSCH transmissions, the following procedures to indicate the UL beams to use for simultaneous PUSCH transmissions may be used.

Initially, under the third proposal, the UE may be configured to use sdmMPTx or fdmMPTx, and may be configured with a single SRS resource set having SRS resources that may be sent over antenna ports across both antenna panels.

In first cases under the third proposal, it may be that txConfig=‘nonCodeBook.’ In such cases, a single SRI bit-field may indicate the UL beams across both UE antenna panels, and may also indicates a number of layers per beam.

For example, assume that each UE antenna panel has 2 antennas, and that an SRS resource set has four SRS resources with usage as ‘nonCodeBook,’ each associated to one of the four antenna ports in the following manner:
(SRS resource #0->port 0, antenna panel 0)
(SRS resource #1->port 1, antenna panel 0)
(SRS resource #2->port 0, antenna panel 1)
(SRS resource #3->port 1, antenna panel 1)

Under these circumstances, if the SRI indicates rank 2 with SRS resources #1 and #2, then the UE uses MPSTx, and simultaneously transmits a first PUSCH on one layer on antenna panel 0 and a second PUSCH on one layer on antenna panel 1.

As another example, under these circumstances, if the SRI indicates rank 3 with SRS resources #1, #2, and #3, the UE uses MPSTx and simultaneously transmits a first PUSCH using one layer on the antenna panel 0 and a second PUSCH using two layers on antenna panel 1.

As another example, under these circumstances, if the SRI indicates rank 2 with SRS resources #0 and #1, the UE uses single panel transmission over antenna panel 0 for each of a first and a second PUSCH if the UE configured for fdmMPTx operation. Under this example, it may be that any SRS resource set indicator is ignored. Further, this example may represent an error case if the UE is instead configured for sdmMPTx (or alternatively, only the first PUSCH is used and the second PUSCH is dropped).

Under these circumstances, it may be that an additional associated channel state information reference signal (CSI-RS) may be configured for the SRS resource set, which is used to derive a precoder for the second antenna panel.

Note that in the first cases under the third proposal, a number of SRS resources per set can be more than four. Further, note that for the case of a single contention window (CW) and MPSTx, a same rank can be applied per antenna panel (e.g., (1,1) or (2,2), etc.), corresponding to a reduction of the size of the SRI bit-field.

In second cases under the third proposal, it may be that txConfig=‘CodeBook.’ In such cases, a single SRI bit-field may indicate number of antenna ports across all antenna panels.

In a first example for second cases under the third proposal, assume each antenna panel has two antennas, and that the SRS resource set has four SRS resources with usage as CodeBook, associated to the antenna panels as follows:
(SRS resource #0->2 ports, ports 0 and 1 of antenna panel 0)
(SRS resource #1->4 ports, ports 0 and 1 of antenna panel 0 and ports 0 and 1 of antenna panel 1)
(SRS resource #2->2 ports, port 1 of antenna panel 0 and port 0 of antenna panel 1)
(SRS resource #3->2 ports, ports 0 and 1 of antenna panel 1)

Note that in second cases under the third proposal, a number of SRS resources per set can be more than four and each SRS resource can have a different number of ports.

For an SRS resource from multiple antenna panels, gNB may indicate two TCI States, and port to TCI association may be predefined or configured by gNB, e.g. for 4-port SRS, port 0 and 2 are associated with the first TCI and port 1 and 3 are associated with the second TCI.

In a first option for second cases under the third proposal, it may be that a single TPMI bit-field indicates a precoding and a number of layers that may be applied over the concatenated antenna panels. In other words, if the indicated SRS is sent over both antenna panels, then both antenna panels will contribute to the transmission of each of the symbols (there is no per panel antenna precoding). In such cases, the bit-field size of the TPMI depends on a maximum possible number of SRS antenna ports (e.g., four under the first example for second cases under the third proposal). Further, as long as the number of ports in any of the SRS resource within the set is two or four, no new design for the TPMI is needed; however, any violation/deviation (e.g., such as using four antennas per port) may use a new TPMI design.

Assume, under this first example for second cases under the third proposal, that the SRI indicates “10”, corresponding to the use of SRS resource #2. In such a case, the UE will use MPSTx (and may use rank 1). Further, PUSCH ports 0 and 2 are associated with the first antenna panel and PUSCH port 1 and 3 are associated with the second antenna panel.

In a second example of second cases under the third proposal, assume each antenna panel has 2 antennas, and that the SRS resource set has four SRS resources with usage as CodeBook, associated to the antenna panels as follows:
(SRS resource #0->1 port, port 1 of antenna panel 0)
(SRS resource #2->2 ports, ports 0 and 1 of antenna panel 1)
(SRS resource #2->2 ports, port 1 of antenna panel 0 and port 0 of antenna panel 1)
(SRS resource #3->3 ports, port 1 of antenna panel 0 and ports 0 and 1 of antenna panel 1)

Again, it is noted that in second cases under the third proposal, a number of SRS resources per set can be more than four and each SRS resource can have a different number of ports.

In a second option for second cases under the third proposal, separate (per antenna panel) TPMI bit-fields each indicate a precoding and a number of layers in a per-antenna-panel manner. In such instances, the bit-field size of the first and second TMPI respectively depend on maximum number of ports in SRS resources corresponding to the first and second antenna panel.

With respect to the second example of second cases under the third proposal, it may be seen that one port for SRS resources can be associated to the first antenna panel and 2 ports for SRS resources associated to the second antenna panel. Further, when assuming SRI indicates “11” (corresponding to SRS resource #3) the UE will be indicated to perform MPSTx. In such circumstances, the first TPMI is determined by one antenna over antenna panel 0 (here it will be simply 1) and the second TPMI is determined by two antennas over antenna panel 1 (which may result rank 1 or rank 2 transmission over antenna panel 1). The use of these TPMIs is illustrated below:

$$[ \begin{matrix}1 & 0 \\ 0 & {P}_{1 , 1} \\ 0 & P 2 , 1\end{matrix} ]$$

In third cases under the third proposal, it may be that a size of an SRS resource set indicator can be reduced to 1 bit (e.g., from two bits as in the case of each of the first proposal and the second proposal discussed herein).

In such cases, it may be that when the SRS resource set indicator is set to 0 in the case where an SRI bit-field indicates SRS resource(s) from both antenna panels, then a first PUSCH may be sent over antenna panel/beam 0 (corresponding to the use of the first SRS resource set), and a second PUSCH may be sent over antenna panel/beam 1 (corresponding to the use of the SRS resource set).

Otherwise, when the SRI bit field indicates SRS resource(s) from a single antenna panel and the UE is configured to use fdmMPTx, it will transmit both the first PUSCH and the second PUSCH over antenna panel 0 (corresponding to the use of the first SRS resource set), or alternatively the UE may only transmit the first PUSCH based on the resources allocated for the first PUSCH or for both the first PUSCH and the second PUSCH. Or, when the SRI bit field indicates SRS resource(s) from a single antenna panel and the UE is configured to use sdmMPTx, the UE may transmit only the first PUSCH over antenna panel 0 (corresponding to the use of the first SRS resource set). Alternatively, this may be understood as an error case.

When the SRS resource set indicator is instead set to 1 and the SRI bit-field indicates SRS resource(s) from both antenna panels then the first PUSCH is sent over antenna panel/beam 1 (corresponding to the use of the second SRS resource set), and the second PUSCH is sent over antenna panel/beam 0 (corresponding to the use of the first SRS resource set)

Otherwise, when the SRI bit field indicates SRS resource(s) from a single antenna panel and the UE is configured to use fdmMPTx, the UE will transmit both the first PUSCH and the second PUSCH over antenna panel 1 (corresponding to the use of the second SRS resource set). Or, when the SRI bit field indicates SRS resource(s) from a single antenna panel and the UE is configured to use sdmMPTx, the UE may transmit only the second PUSCH over antenna panel 1 (corresponding to the use of the second SRS resource set). Alternatively, this may be understood as an error case.

### Embodiments of Antenna Port Indications for MPSTx

Under a first proposal for antenna port indications for MPSTx, for the case of s-DCI and FDMed MPSTx, the following procedures for DMRS antenna port indication may be used.

In a first case where a use of a different number of layers per antenna panel is not allowed, a single ‘antenna ports’ bit-field indicates DMRS ports. Then, for each PUSCH, the corresponding UL beam (and precoding in the case of CB-based applications) is applied according to one of the first proposal through the third proposal for beam indications for MPSTx as discussed herein.

In a second case where a use of a different number of layers per antenna panel is allowed (e.g., for multi-TB scenario), in a first option, the ‘antenna ports’ bit-field indicates DMRS ports for the antenna panel having a maximum number of layers. Note that the procedure is also applicable to the case both antenna panels have same number of layers.

Under a first alternative of this first option, DMRS ports for the antenna panel with the fewer number of layers is determined using the smallest port indices for the set of ports associated with the antenna panel with the greater number of layers. For example, it may be that a PUSCH on antenna panel 0 uses one layer, and that a PUSCH on antenna panel 1 uses two layers, and that the ‘antenna ports’ field indicates DMRS ports 0 and 1 for the second antenna panel. In this case, the UE may conclude that the DMRS port for the first antenna panel is 0.

Under this first alternative of this first option, a ‘number of CDM group(s) without data’ indicated by ‘antenna ports’ may be applied to both PUSCHs. Alternatively, it may be that the UE expects for the MPSTx case that the ‘number of CDM group(s) without data’ is two for dmrs-Type=1 or is three for dmrs-Type=2.

Under a second alternative of this first option, reserved bits in DMRS tables for cases where rank is greater than one are used to indicate an associated port index to the antenna panel having a fewer number of layers. Again, for example, it may be that a PUSCH on antenna panel 0 uses one layer, and that a PUSCH on antenna panel 1 uses two layers. In the case that the ‘antenna port’ bit-field value is 1, the UE may conclude that antenna panel 1 uses DMRS ports 0 and 1, and that antenna panel 0 uses DMRS port 0. In an alternative case where the ‘antenna port’ bit-field value is 4, the UE may conclude that antenna panel 1 uses DMRS ports 0 and 1 and that antenna panel 0 uses DMRS port 1

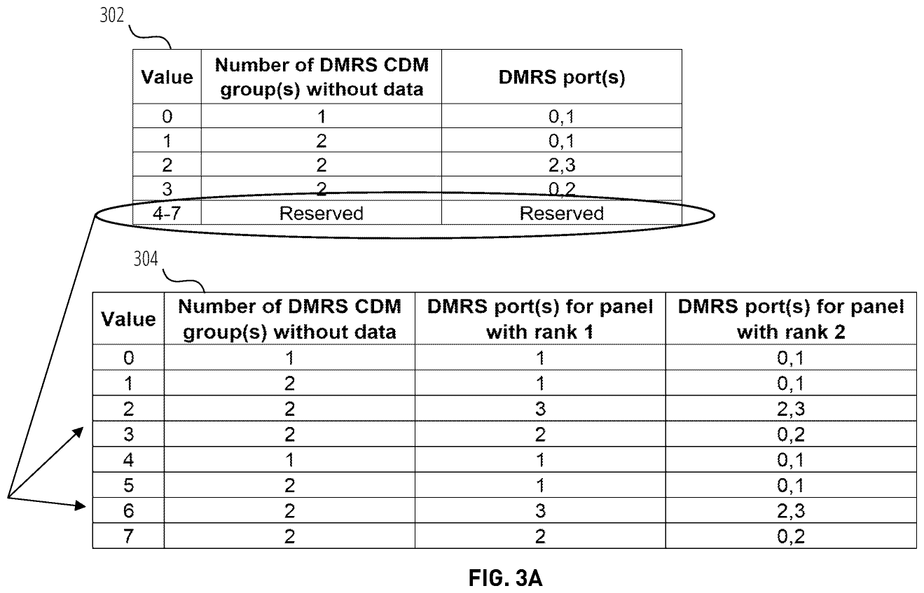

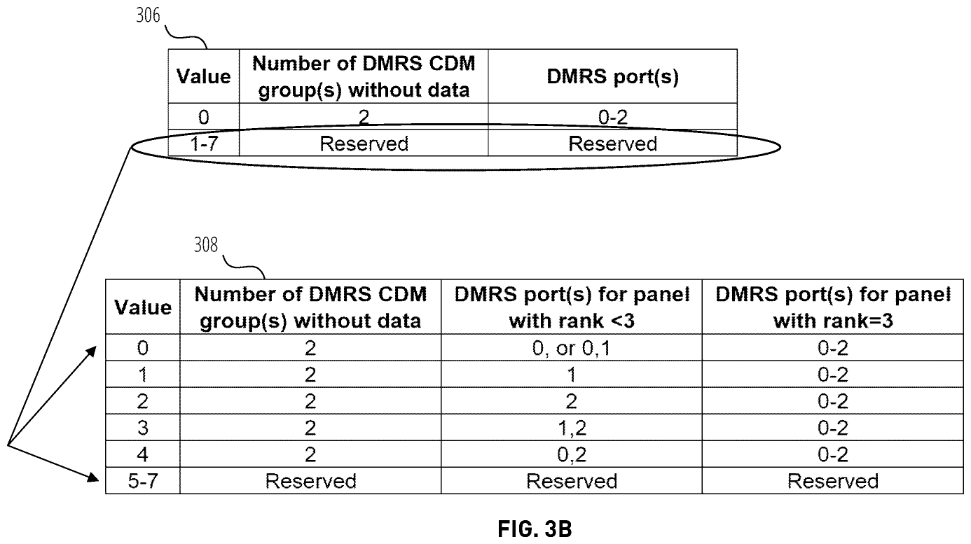

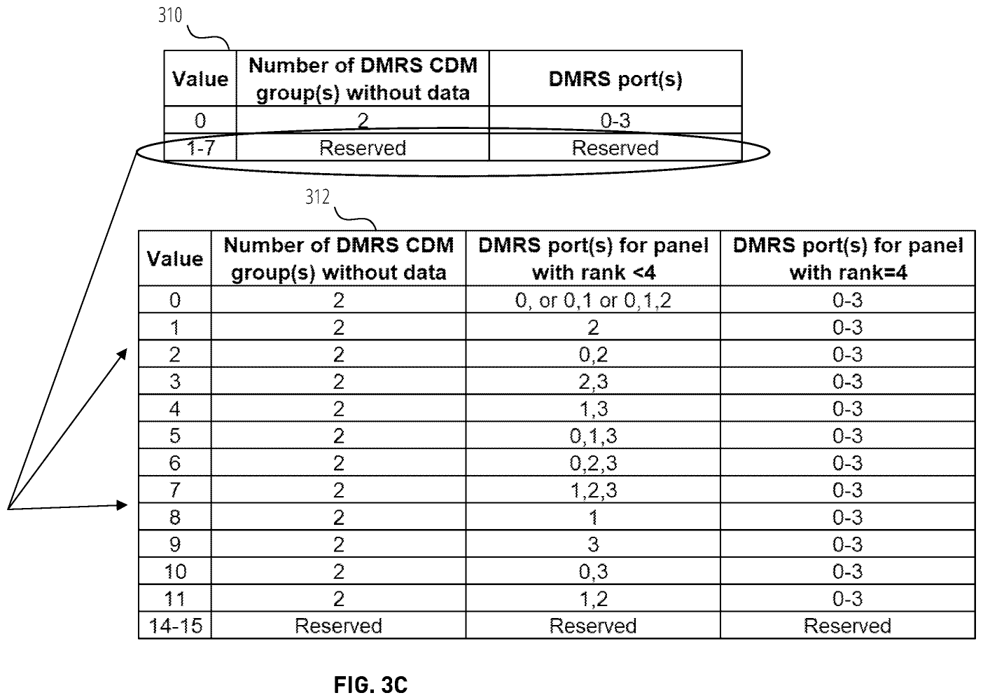

For example, FIG. 3A, FIG. 3B, and FIG. 3C illustrate example DMRS tables used to indicate the associated port index to the antenna panel with smaller number of layers, according to the second alternative of the first option. In FIG. 3A, table 302 is for legacy rank 2 (see TS 38.212, Version 17.1.0 (2022-03), Table 7.3.1.1.2-9), while table 304 is for new rank arrangements (1,2) and (2,2). In FIG. 3B, table 306 is for legacy rank 3 (see 3GPP TS 38.212, Version 17.1.0 (2022-03), Table 7.3.1.1.2-10) and table 308 is for new rank arrangements (1,3), (2,3), and (3,3), Table 7.3.1.1.2-10). In FIG. 3C, table 310 is for legacy rank 4 (see 3GPP TS 38.212, Version 17.1.0 (2022-03), Table 7.3.1.1.2-11) while table 312 is for new associated rank arrangements. Note that, in certain embodiments, the rank 4 case may need a new table. Alternatively, some rows for rank 4 may be excluded (e.g., only the first eight rows are kept).

Under a second option of the second case where a use of a different number of layers per antenna panel is allowed, an additional ‘antenna port’ bit-field may be introduced that is used to make an independent indication of DMRS ports for the PUSCH associated with the second SRI bit-field. Alternatively/additionally, it may be that the first ‘antenna port’ bit-field is always associated to the first PUSCH and the second ‘antenna port’ bit-field is always associated with the second PUSCH (or vise versa).

Under a second proposal for antenna port indications for MPSTx, for the case of s-DCI and SDMed MPSTx, the following procedures for DMRS antenna port indication may be used.

It may be that DMRS ports associated to different antenna panels are to be within separate CDM groups, and that the UE expects, for MPSTx, that a ‘number of CDM group(s) without data’ is two for dmrs-Type=1, and that the ‘number of CDM group(s) without data’ is three or two for dmrs-Type=2.

In a first option under the second proposal, it may be that a single ‘antenna ports’ bit-field indicates DMRS ports for the total number of layers across both antenna panels. In such circumstances where a total number of layers is up to 4, any of rank 2 for (1,1), rank 3 for (1,2) or (2,1), and rank 4 for (1,3), (3,1), (2,2) may be used. In such circumstances, from the set of DMRS ports indicated by single ‘antenna ports’ bit-field, the indices corresponding to the first CDM group are associated with the PUSCH corresponding to the first SRI bit-field. Alternatively, it may be that DMRS port indices corresponding to the first CDM group are always associated with the first PUSCH.

In a second option under the second proposal, an additional ‘antenna port’ bit-field may be introduced for the PUSCH associated with the second SRI bit-field.

### Additional Embodiments for UL Beam and Precoding Indication

In Rel-17, when a UE is indicated to perform PUSCH repetition in time with different UL beams associated to each repetition, an SRI bit-field is extended to indicate a beam association to each repetition. Rel-17 also specifies a unified TCI framework, based on which when the UE is configured DLorJointTCIState or UL-TCIState, the UE shall perform PUSCH transmission according to the spatial relation, if applicable, with a reference to the reference signal (RS) for determining UL Tx spatial filter or the RS configured with qcl-Type set to ‘typeD’ of the indicated DLorJointTCIState or UL-TCIState (see TS 38.214, Clause 6.1).

A unified TCI framework may be extended for UL beam indication for multi-panel simultaneous PUSCH transmissions. For example, for multi-panel PUSCH beam indication, a combination of the Rel-17 procedure and a unified TCI framework may be used as follows. First, the UE may be configured with two SRS resource sets both with the usage of value ‘nonCodeBook,’ when txConfig=‘nonCodeBook’, or two SRS resource sets with usage of value ‘CodeBook,’ when txConfig=‘CodeBook.’ Further, each SRS resource set may be associated with each indicated joint or uplink TCI for PUSCH beam indication.

Based on this, the following proposal may be stated: for s-DCI, at least for FDM resource allocation of multi-panel simultaneous PUSCH transmissions, a Rel-17 procedure to indicate UL beam where each SRS resource set is associated with each indicated joint or uplink TCI for PUSCH beam indication may be used. Further, if only one TCI is indicated, UE does not expect SRS resource set indicator bit-field to indicate codepoint 10, or 11.

It may be that a rote extension of Rel-17 beam indication procedure has some drawbacks. For example, In Rel-17, PUSCHs on separate beams are not simultaneous but rather are in different time resources, so this indication does not capture inter-panel interference for SDM (although sufficient for the case of FDM). In addition, in Rel-17, PUSCHs on different beams are simply repetitions in time which have same number of layers. While, for simultaneous transmission of a single TB through multi-beams, per-panel modulation and coding scheme (MCS)/number of layers is not supported in Rel-17, the Rel-17 indication needs modification if different number of layers per panel is needed (for example, for a two codeword case).

Accordingly, the following proposal may be stated: for s-DCI, at least for two codewords multi-panel simultaneous PUSCH transmissions, in the case of txConfig=‘nonCodeBook,’ the second SRI bit field may assume all possible ranks for the corresponding SRS resource set (similar to the first SRI bit-field), without any dependency on the rank from the first SRI. This may increase DCI size by up to 1 bit. Further, in the case of txConfig=‘CodeBook,’ the second TPMI bit-field indicates all possible number of layers for the corresponding beam/panel.

Note that this proposal may increase DCI size by up to 1 bit for txConfig=‘nonCodeBook.’ For txConfig=‘CodeBook,’ this proposal may increase DCI size by up to one bit in most cases and two bits only for the special case of “4 antenna ports, disabled transform precoder, maxRank=3 or 4, ul-FullPowerTransmission=fullpowerModel, and codebookSubset=partialAndNonCoherent”. To reduce DCI size, a second proposal may be that the UE indicates a maximum number of layers per panel for MP simultaneous PUSCHs. In such cases, the maximum rank for each panel, e.g. maximum rank for PUSCH associated with each SRS resource set, can be configured by RRC signaling (for example: (1,1), (2,1), (1,2), (2,2) (and note that in such an (a,b) indication, neither a nor b can be larger than Lₘₐₓ))

### Additional Embodiments for UL Antenna Port Indication

For s-DCI indication of FDM multi-panel simultaneous PUSCH transmissions, if a different number of layers per panel is not allowed, then a single “Antenna ports” bit-field indicates DMRS ports for both PUSCHs. In this case, it may be that no new specification is needed. For the case that different number of layers per panel is allowed (for example for a two codewords scenario), the following proposal to indicate DMRS ports for PUSCHs may be stated: for s-DCI FDM simultaneous PUSCHs, an “Antenna ports” bit-field indicates DMRS ports for the PUSCH with maximum number of layers. In first such cases, DMRS ports for the panel with a smaller number of layers are determined from the smallest port indices within the set of ports associated to the panel with a greater number of layers. In second such cases, reserved bits in DMRS tables for rank>1 are used to indicate the associated port index to the panel with smaller number of layers, based on modified tables in FIG. 3A, FIG. 3B, and FIG. 3C.

As an example for the first set of cases, consider the case that a PUSCH associated to a 1^{st} panel has 1 layer, and a PUSCH associated to a 2^{nd} panel has 2 layers. An “Antenna ports” bit-field in DCI indicates DMRS ports 0,1 for the 2^{nd} panel. Therefore, DMRS port for the 1^{st} panel is 0. As an example for the second set of cases, consider a similar example to the first set of cases in view of the table shown in FIG. 3A (a modified version of Table 7.3.1.1.2-9 from 3GPP TS 38.212, Version 17.1.0 (2022-03)). If the value of “antenna port” bit-field is 1, the 2^{nd} panel has DMRS ports 0,1 and 1^{st} panel has DMRS port 0. On the other hand, if the value of “antenna port” bit-field is 4, the 2^{nd} panel has DMRS ports 0,1 and 1^{st} panel has DMRS port 0.

Also note that under the second set of cases, when one of the PUSCHs is rank 4, a DMRS port indication to the other PUSCH under all possible ranks, i.e., 1-4, may use an extended version of the legacy Table 7.3.1.1.2-11 from 3 bits to 4 bits (e.g., as shown in FIG. 3C). Alternatively, some rows may be excluded (e.g., it may be that only the first eight rows of this table are kept).

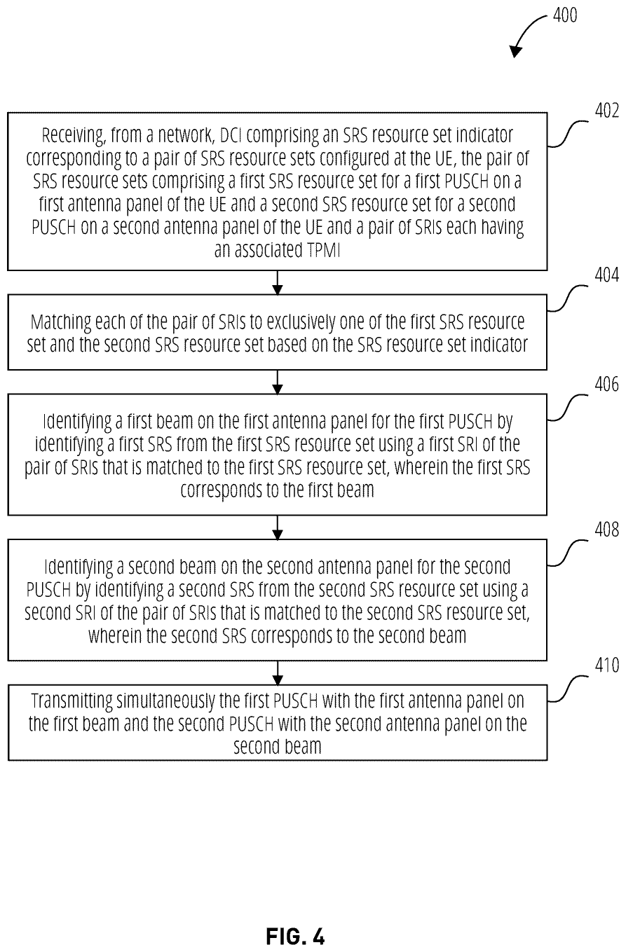

FIG. 4 illustrates a method 400 of a UE, according to embodiments herein. The method 400 includes receiving 402, from a network, DCI comprising an SRS resource set indicator corresponding to a pair of SRS resource sets configured at the UE, the pair of SRS resource sets comprising a first SRS resource set for a first PUSCH on a first antenna panel of the UE and a second SRS resource set for a second PUSCH on a second antenna panel of the UE; and a pair of SRIs each having an associated TPMI.

The method 400 further includes matching 404 each of the pair of SRIs to exclusively one of the first SRS resource set and the second SRS resource set based on the SRS resource set indicator.

The method 400 further includes identifying 406 a first beam on the first antenna panel for the first PUSCH by identifying a first SRS from the first SRS resource set using a first SRI of the pair of SRIs that is matched to the first SRS resource set, wherein the first SRS corresponds to the first beam.

The method 400 further includes identifying 408 a second beam on the second antenna panel for the second PUSCH by identifying a second SRS from the second SRS resource set using a second SRI of the pair of SRIs that is matched to the second SRS resource set, wherein the second SRS corresponds to the second beam.

The method 400 further includes transmitting 410 simultaneously the first PUSCH with the first antenna panel on the first beam and the second PUSCH with the second antenna panel on the second beam.

In some embodiments of the method 400, the first PUSCH is transmitted using a first number of layers indicated by the TPMI associated with the first SRI, and the second PUSCH is transmitted according to a second number of layers indicated by the second TPMI associated with the second SRI that is different than the first number of layers.

In some embodiments, the method 400 further includes indicating, to the network, a first maximum rank for the first antenna panel and a second maximum rank for the second antenna panel; wherein a first rank of the first PUSCH is less than or equal to the first maximum rank and a second rank of the second PUSCH is less than or equal to the second maximum rank.

In some embodiments, the method 400 further includes determining, based on the SRS resource set indicator, that DMRS ports used to transmit the first PUSCH may be from separate CDM groups and transmitting the first PUSCH using a first DMRS port from a first CDM group and a second DMRS port from a second CDM group.

In some embodiments, the method 400 further includes determining, based on the SRS resource set indicator, that DMRS ports used to transmit the first PUSCH may not be from separate CDM groups and transmitting the first PUSCH using a plurality of DMRS ports from a same CDM group.

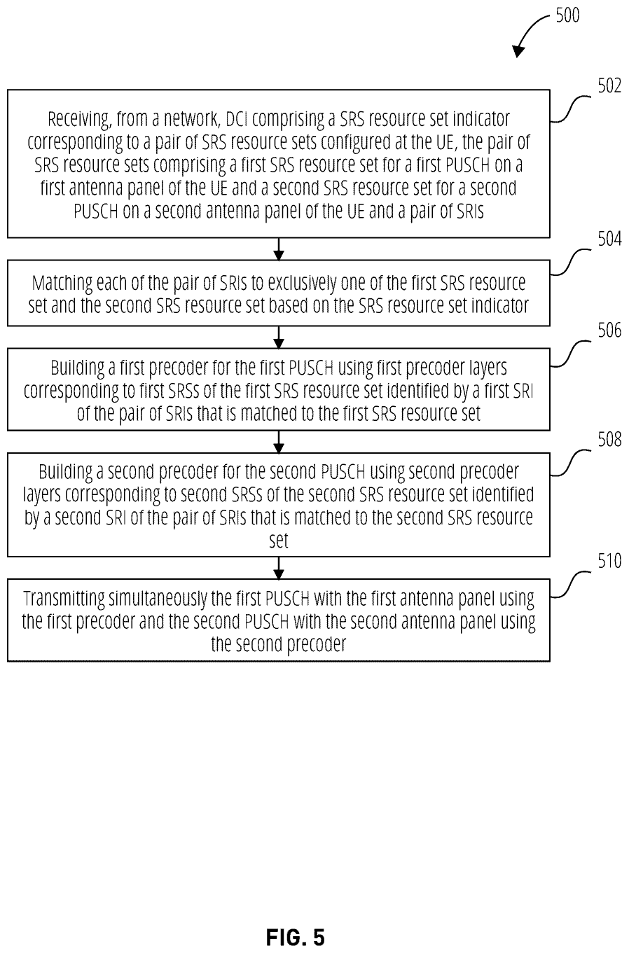

FIG. 5 illustrates a method 500 of a UE, according to embodiments herein. The method 500 includes receiving 502, from a network, DCI comprising an SRS resource set indicator corresponding to a pair of SRS resource sets configured at the UE, the pair of SRS resource sets comprising a first SRS resource set for a PUSCH on a first antenna panel of the UE, and a second SRS resource set for a second PUSCH on a second antenna panel of the UE and a pair of SRIs.

The method 500 further includes matching 504 each of the pair of SRIs to exclusively one of the first SRS resource set and the second SRS resource set based on the SRS resource set indicator.

The method 500 further includes building 506 a first precoder for the first PUSCH using first precoder layers corresponding to first SRSs of the first SRS resource set identified by a first SRI of the pair of SRIs that is matched to the first SRS resource set.

The method 500 further includes building 508 a second precoder for the second PUSCH using second precoder layers corresponding to second SRSs of the second SRS resource set identified by a second SRI of the pair of SRIs that is matched to the second SRS resource set.

The method 500 further includes transmitting 510 simultaneously the first PUSCH with the first antenna panel using the first precoder and the second PUSCH with the second antenna panel using the second precoder.

In some embodiments of the method 500, a first number of precoder layers of the first precoder is different than a second number of precoder layers of the second precoder.

In some embodiments, the method 500 further includes indicating, to the network, a first maximum rank for the first antenna panel and a second maximum rank for the second antenna panel, wherein a first rank of the first PUSCH is less than or equal to the first maximum rank and a second rank of the second PUSCH is less than or equal to the second maximum rank.

In some embodiments of the method 500, a first bit field size for the first SRI is a function of a first total number of SRSs in the first SRS resource set and a first maximum rank for the first antenna panel. In some such embodiments, a second bit field size for the second SRI is a function of a second total number of SRSs in the second SRS resource set and a second maximum rank for the second antenna panel.

In some embodiments, the method 500 further includes determining, based on the SRS resource set indicator, that DMRS ports used to transmit the first PUSCH may be from separate CDM groups; and transmitting the first PUSCH using a first DMRS port from a first CDM group and a second DMRS port from a second CDM group.

In some embodiments, the method 500 further includes determining, based on the SRS resource set indicator, that DMRS ports used to transmit the first PUSCH may not be from separate CDM groups and transmitting the first PUSCH using a plurality of DMRS ports from a same CDM group.

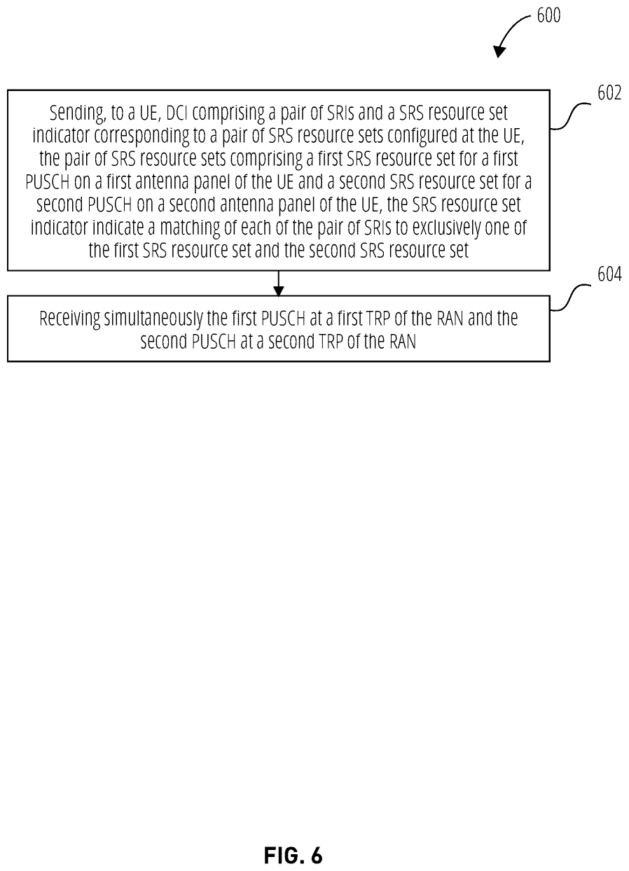

FIG. 6 illustrates a method 600 of a RAN, according to embodiments herein. The method 600 includes sending 602, to a UE, DCI comprising a pair of SRIs and a SRS resource set indicator corresponding to a pair of SRS resource sets configured at the UE, the pair of SRS resource sets comprising a first SRS resource set for a first PUSCH on a first antenna panel of the UE and a second SRS resource set for a second PUSCH on a second antenna panel of the UE, the SRS resource set indicator indicates a matching of each of the pair of SRIs to exclusively one of the first SRS resource set and the second SRS resource set.

The method 600 further includes receiving 604 simultaneously the first PUSCH at a first TRP of the RAN and the second PUSCH at a second TRP of the RAN.

In some embodiments of the method 600, the DCI further includes a first TPMI associated with a first SRI of the pair of SRIs that indicates a first number of layers and a second TPMI associated with a second SRI of the pair of SRIs that indicates a second number of layers.

In some embodiments of the method 600, a first SRI of the pair of SRIs is configured to indicate a first number of precoder layers when applied with its matched one of the first SRS resource set and the second SRS resource set, the second SRI of the pair of SRIs is configured to identify a second number of precoder layers when applied with its matched one of the first SRS resource set and the second SRS resource set, and the first number of precoder layers is different than the second number of precoder layers.

In some embodiments, the method 600 further includes receiving, from the UE, a first maximum rank for to the first antenna panel and a second maximum rank for the second antenna panel, and wherein a first rank of the first PUSCH is less than or equal to the first maximum rank and a second rank of the second PUSCH is less than or equal to the second maximum rank.

In some embodiments, the method 600 further includes selecting the SRS resource set indicator to indicate whether DMRS ports used to transmit the first PUSCH may be from separate CDM groups.

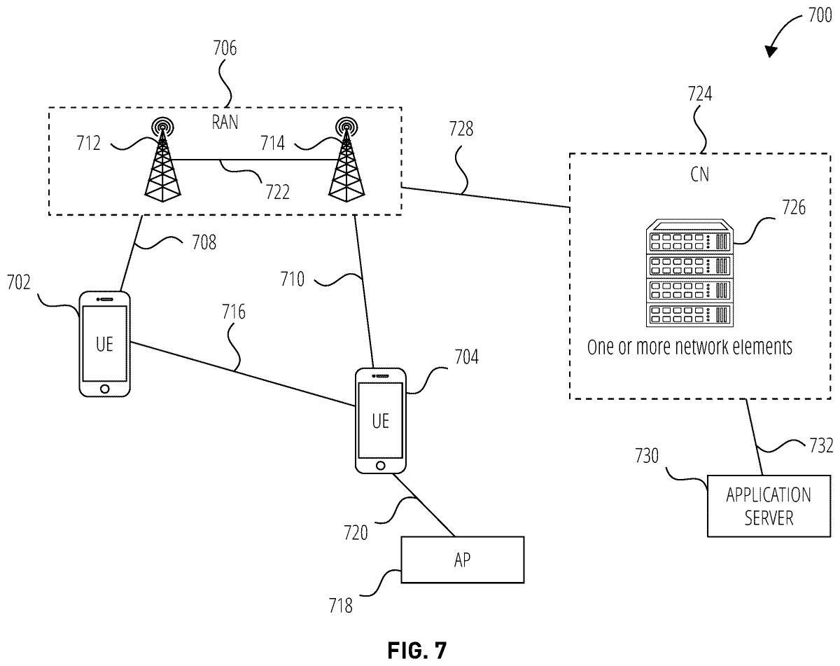

FIG. 7 illustrates an example architecture of a wireless communication system 700, according to embodiments disclosed herein. The following description is provided for an example wireless communication system 700 that operates in conjunction with the LTE system standards and/or 5G or NR system standards as provided by 3GPP technical specifications.

As shown by FIG. 7, the wireless communication system 700 includes UE 702 and UE 704 (although any number of UEs may be used). In this example, the UE 702 and the UE 704 are illustrated as smartphones (e.g., handheld touchscreen mobile computing devices connectable to one or more cellular networks), but may also comprise any mobile or non-mobile computing device configured for wireless communication.

The UE 702 and UE 704 may be configured to communicatively couple with a RAN 706. In embodiments, the RAN 706 may be NG-RAN, E-UTRAN, etc. The UE 702 and UE 704 utilize connections (or channels) (shown as connection 708 and connection 710, respectively) with the RAN 706, each of which comprises a physical communications interface. The RAN 706 can include one or more base stations, such as base station 712 and base station 714, that enable the connection 708 and connection 710.

In this example, the connection 708 and connection 710 are air interfaces to enable such communicative coupling, and may be consistent with RAT(s) used by the RAN 706, such as, for example, an LTE and/or NR.

In some embodiments, the UE 702 and UE 704 may also directly exchange communication data via a sidelink interface 716. The UE 704 is shown to be configured to access an access point (shown as AP 718) via connection 720. By way of example, the connection 720 can comprise a local wireless connection, such as a connection consistent with any IEEE 802.11 protocol, wherein the AP 718 may comprise a Wi-Fi© router. In this example, the AP 718 may be connected to another network (for example, the Internet) without going through a CN 724.

In embodiments, the UE 702 and UE 704 can be configured to communicate using orthogonal frequency division multiplexing (OFDM) communication signals with each other or with the base station 712 and/or the base station 714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 712 or base station 714 may be implemented as one or more software entities running on server computers as part of a virtual network. In addition, or in other embodiments, the base station 712 or base station 714 may be configured to communicate with one another via interface 722. In embodiments where the wireless communication system 700 is an LTE system (e.g., when the CN 724 is an EPC), the interface 722 may be an X2 interface. The X2 interface may be defined between two or more base stations (e.g., two or more eNBs and the like) that connect to an EPC, and/or between two eNBs connecting to the EPC. In embodiments where the wireless communication system 700 is an NR system (e.g., when CN 724 is a 5GC), the interface 722 may be an Xn interface. The Xn interface is defined between two or more base stations (e.g., two or more gNBs and the like) that connect to 5GC, between a base station 712 (e.g., a gNB) connecting to 5GC and an eNB, and/or between two eNBs connecting to 5GC (e.g., CN 724).

The RAN 706 is shown to be communicatively coupled to the CN 724. The CN 724 may comprise one or more network elements 726, which are configured to offer various data and telecommunications services to customers/subscribers (e.g., users of UE 702 and UE 704) who are connected to the CN 724 via the RAN 706. The components of the CN 724 may be implemented in one physical device or separate physical devices including components to read and execute instructions from a machine-readable or computer-readable medium (e.g., a non-transitory machine-readable storage medium).

In embodiments, the CN 724 may be an EPC, and the RAN 706 may be connected with the CN 724 via an S1 interface 728. In embodiments, the S1 interface 728 may be split into two parts, an S1 user plane (S1-U) interface, which carries traffic data between the base station 712 or base station 714 and a serving gateway (S-GW), and the S1-MME interface, which is a signaling interface between the base station 712 or base station 714 and mobility management entities (MMEs).

In embodiments, the CN 724 may be a 5GC, and the RAN 706 may be connected with the CN 724 via an NG interface 728. In embodiments, the NG interface 728 may be split into two parts, an NG user plane (NG-U) interface, which carries traffic data between the base station 712 or base station 714 and a user plane function (UPF), and the S1 control plane (NG-C) interface, which is a signaling interface between the base station 712 or base station 714 and access and mobility management functions (AMFs).

Generally, an application server 730 may be an element offering applications that use internet protocol (IP) bearer resources with the CN 724 (e.g., packet switched data services). The application server 730 can also be configured to support one or more communication services (e.g., VoIP sessions, group communication sessions, etc.) for the UE 702 and UE 704 via the CN 724. The application server 730 may communicate with the CN 724 through an IP communications interface 732.

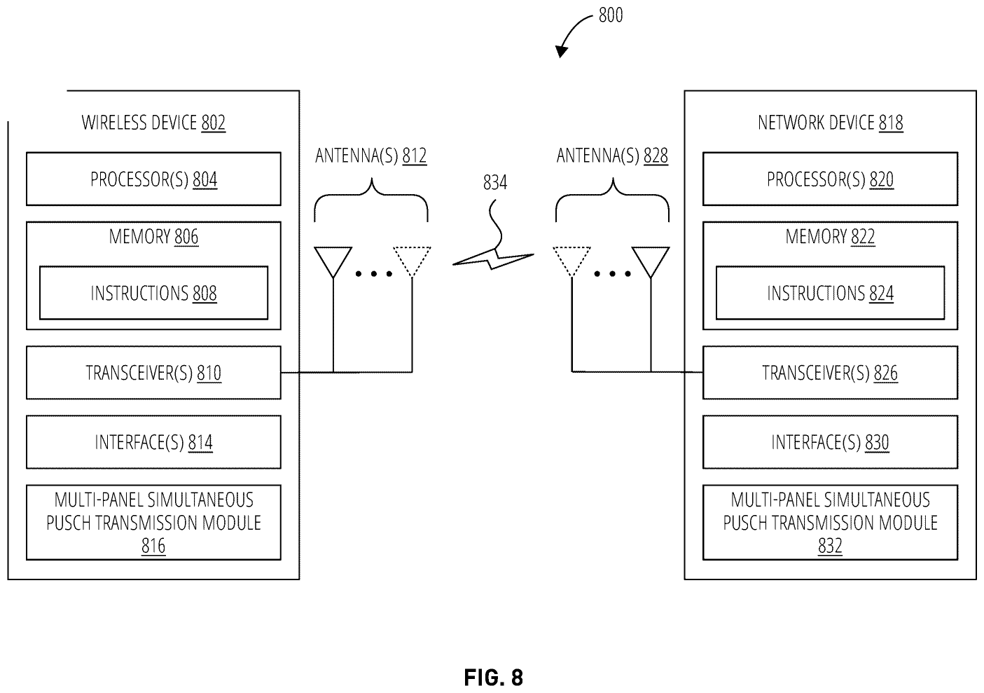

FIG. 8 illustrates a system 800 for performing signaling 834 between a wireless device 802 and a network device 818, according to embodiments disclosed herein. The system 800 may be a portion of a wireless communications system as herein described. The wireless device 802 may be, for example, a UE of a wireless communication system. The network device 818 may be, for example, a base station (e.g., an eNB or a gNB) of a wireless communication system.

The wireless device 802 may include one or more processor(s) 804. The processor(s) 804 may execute instructions such that various operations of the wireless device 802 are performed, as described herein. The processor(s) 804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 802 may include a memory 806. The memory 806 may be a non-transitory computer-readable storage medium that stores instructions 808 (which may include, for example, the instructions being executed by the processor(s) 804). The instructions 808 may also be referred to as program code or a computer program. The memory 806 may also store data used by, and results computed by, the processor(s) 804.

The wireless device 802 may include one or more transceiver(s) 810 that may include radio frequency (RF) transmitter and/or receiver circuitry that use the antenna(s) 812 of the wireless device 802 to facilitate signaling (e.g., the signaling 834) to and/or from the wireless device 802 with other devices (e.g., the network device 818) according to corresponding RATs.

The wireless device 802 may include one or more antenna(s) 812 (e.g., one, two, four, or more). For embodiments with multiple antenna(s) 812, the wireless device 802 may leverage the spatial diversity of such multiple antenna(s) 812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 802 may be accomplished according to precoding (or digital beamforming) that is applied at the wireless device 802 that multiplexes the data streams across the antenna(s) 812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 802 may implement analog beamforming techniques, whereby phases of the signals sent by the antenna(s) 812 are relatively adjusted such that the (joint) transmission of the antenna(s) 812 can be directed (this is sometimes referred to as beam steering).

The wireless device 802 may include one or more interface(s) 814. The interface(s) 814 may be used to provide input to or output from the wireless device 802. For example, a wireless device 802 that is a UE may include interface(s) 814 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 810/antenna(s) 812 already described) that allow for communication between the UE and other devices and may operate according to known protocols (e.g., Wi-Fi®, Bluetooth®, and the like).

The wireless device 802 may include a multi-panel simultaneous PUSCH transmission module 816. The multi-panel simultaneous PUSCH transmission module 816 may be implemented via hardware, software, or combinations thereof. For example, the multi-panel simultaneous PUSCH transmission module 816 may be implemented as a processor, circuit, and/or instructions 808 stored in the memory 806 and executed by the processor(s) 804. In some examples, the multi-panel simultaneous PUSCH transmission module 816 may be integrated within the processor(s) 804 and/or the transceiver(s) 810. For example, the multi-panel simultaneous PUSCH transmission module 816 may be implemented by a combination of software components (e.g., executed by a DSP or a general processor) and hardware components (e.g., logic gates and circuitry) within the processor(s) 804 or the transceiver(s) 810.

The multi-panel simultaneous PUSCH transmission module 816 may be used for various aspects of the present disclosure, as described herein, for example, aspects of FIG. 1 through FIG. 6. For example, the multi-panel simultaneous PUSCH transmission module 832 may configure the wireless device 802 to transmit multi-panel simultaneous PUSCH transmissions as described herein.

The network device 818 may include one or more processor(s) 820. The processor(s) 820 may execute instructions such that various operations of the network device 818 are performed, as described herein. The processor(s) 820 may include one or more baseband processors implemented using, for example, a CPU, a DSP, an ASIC, a controller, an FPGA device, another hardware device, a firmware device, or any combination thereof configured to perform the operations described herein.

The network device 818 may include a memory 822. The memory 822 may be a non-transitory computer-readable storage medium that stores instructions 824 (which may include, for example, the instructions being executed by the processor(s) 820). The instructions 824 may also be referred to as program code or a computer program. The memory 822 may also store data used by, and results computed by, the processor(s) 820.

The network device 818 may include one or more transceiver(s) 826 that may include RF transmitter and/or receiver circuitry that use the antenna(s) 828 of the network device 818 to facilitate signaling (e.g., the signaling 834) to and/or from the network device 818 with other devices (e.g., the wireless device 802) according to corresponding RATs.

The network device 818 may include one or more antenna(s) 828 (e.g., one, two, four, or more). In embodiments having multiple antenna(s) 828, the network device 818 may perform MIMO, digital beamforming, analog beamforming, beam steering, etc., as has been described.

The network device 818 may include one or more interface(s) 830. The interface(s) 830 may be used to provide input to or output from the network device 818. For example, a network device 818 that is a base station may include interface(s) 830 made up of transmitters, receivers, and other circuitry (e.g., other than the transceiver(s) 826/antenna(s) 828 already described) that enables the base station to communicate with other equipment in a core network, and/or that enables the base station to communicate with external networks, computers, databases, and the like for purposes of operations, administration, and maintenance of the base station or other equipment operably connected thereto.

The network device 818 may include a multi-panel simultaneous PUSCH transmission module 832. The multi-panel simultaneous PUSCH transmission module 832 may be implemented via hardware, software, or combinations thereof. For example, the multi-panel simultaneous PUSCH transmission module 832 may be implemented as a processor, circuit, and/or instructions 824 stored in the memory 822 and executed by the processor(s) 820. In some examples, the multi-panel simultaneous PUSCH transmission module 832 may be integrated within the processor(s) 820 and/or the transceiver(s) 826. For example, the multi-panel simultaneous PUSCH transmission module 832 may be implemented by a combination of software components (e.g., executed by a DSP or a general processor) and hardware components (e.g., logic gates and circuitry) within the processor(s) 820 or the transceiver(s) 826.

The multi-panel simultaneous PUSCH transmission module 832 may be used for various aspects of the present disclosure, as described herein, for example, aspects of FIG. 1 through FIG. 6. For example, the multi-panel simultaneous PUSCH transmission module 832 may configure the network device 818 to receive multi-panel simultaneous PUSCH transmissions as described herein.

Embodiments contemplated herein include an apparatus comprising means to perform one or more elements of any of the method 400 and the method 500. This apparatus may be, for example, an apparatus of a UE (such as a wireless device 802 that is a UE, as described herein).

Embodiments contemplated herein include one or more non-transitory computer-readable media comprising instructions to cause an electronic device, upon execution of the instructions by one or more processors of the electronic device, to perform one or more elements of any of the method 400 and the method 500. This non-transitory computer-readable media may be, for example, a memory of a UE (such as a memory 806 of a wireless device 802 that is a UE, as described herein).

Embodiments contemplated herein include an apparatus comprising logic, modules, or circuitry to perform one or more elements of any of the method 400 and the method 500. This apparatus may be, for example, an apparatus of a UE (such as a wireless device 802 that is a UE, as described herein).

Embodiments contemplated herein include an apparatus comprising: one or more processors and one or more computer-readable media comprising instructions that, when executed by the one or more processors, cause the one or more processors to perform one or more elements of any of the method 400 and the method 500. This apparatus may be, for example, an apparatus of a UE (such as a wireless device 802 that is a UE, as described herein).

Embodiments contemplated herein include a signal as described in or related to one or more elements of any of the method 400 and the method 500.

Embodiments contemplated herein include a computer program or computer program product comprising instructions, wherein execution of the program by a processor is to cause the processor to carry out one or more elements of any of the method 400 and the method 500. The processor may be a processor of a UE (such as a processor(s) 804 of a wireless device 802 that is a UE, as described herein). These instructions may be, for example, located in the processor and/or on a memory of the UE (such as a memory 806 of a wireless device 802 that is a UE, as described herein).

Embodiments contemplated herein include an apparatus comprising means to perform one or more elements of the method 600. This apparatus may be, for example, an apparatus of a base station (such as a network device 818 that is a base station, as described herein).

Embodiments contemplated herein include one or more non-transitory computer-readable media comprising instructions to cause an electronic device, upon execution of the instructions by one or more processors of the electronic device, to perform one or more elements of the method 600. This non-transitory computer-readable media may be, for example, a memory of a base station (such as a memory 822 of a network device 818 that is a base station, as described herein).

Embodiments contemplated herein include an apparatus comprising logic, modules, or circuitry to perform one or more elements of the method 600. This apparatus may be, for example, an apparatus of a base station (such as a network device 818 that is a base station, as described herein).

Embodiments contemplated herein include an apparatus comprising: one or more processors and one or more computer-readable media comprising instructions that, when executed by the one or more processors, cause the one or more processors to perform one or more elements of the method 600. This apparatus may be, for example, an apparatus of a base station (such as a network device 818 that is a base station, as described herein).

Embodiments contemplated herein include a signal as described in or related to one or more elements of the method 600.

Embodiments contemplated herein include a computer program or computer program product comprising instructions, wherein execution of the program by a processing element is to cause the processing element to carry out one or more elements of the method 600. The processor may be a processor of a base station (such as a processor(s) 820 of a network device 818 that is a base station, as described herein).

These instructions may be, for example, located in the processor and/or on a memory of the base station (such as a memory 822 of a network device 818 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users.

In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
receiving, from a network, downlink control information (DCI) comprising:
a sounding reference signal (SRS) resource set indicator corresponding to a pair of SRS resource sets configured at the UE, the pair of SRS resource sets comprising a first SRS resource set for a first physical uplink shared channel (PUSCH) on a first antenna panel of the UE and a second SRS resource set for a second PUSCH on a second antenna panel of the UE, and
a pair of SRS resource indicators (SRIs) each having an associated transmit precoder matrix indicator (TPMI);
matching each of the pair of SRIs to exclusively one of the first SRS resource set and the second SRS resource set based on the SRS resource set indicator;
identifying a first beam on the first antenna panel for the first PUSCH by identifying a first SRS from the first SRS resource set using a first SRI of the pair of SRIs that is matched to the first SRS resource set, wherein the first SRS corresponds to the first beam;
identifying a second beam on the second antenna panel for the second PUSCH by identifying a second SRS from the second SRS resource set using a second SRI of the pair of SRIs that is matched to the second SRS resource set, wherein the second SRS corresponds to the second beam; and
transmitting simultaneously the first PUSCH with the first antenna panel on the first beam and the second PUSCH with the second antenna panel on the second beam.

2. The method of claim 1, wherein the first PUSCH is transmitted using a first number of layers indicated by the TPMI associated with the first SRI, and wherein the second PUSCH is transmitted according to a second number of layers indicated by the second TPMI associated with the second SRI that is different than the first number of layers.

3. The method of claim 1, further comprising indicating, to the network, a first maximum rank for the first antenna panel and a second maximum rank for the second antenna panel; wherein:
a first rank of the first PUSCH is less than or equal to the first maximum rank; and
a second rank of the second PUSCH is less than or equal to the second maximum rank.

4. The method of claim 1, further comprising:
determining, based on the SRS resource set indicator, that demodulation reference signal (DMRS) ports used to transmit the first PUSCH may be from separate code division multiplexing (CDM) groups; and
transmitting the first PUSCH using a first DMRS port from a first CDM group and a second DMRS port from a second CDM group.

5. The method of claim 1, further comprising:
determining, based on the SRS resource set indicator, that demodulation reference signal (DMRS) ports used to transmit the first PUSCH may not be from separate code division multiplexing (CDM) groups; and
transmitting the first PUSCH using a plurality of DMRS ports from a same CDM group.

6. A method of a user equipment (UE), comprising:
receiving, from a network, downlink control information (DCI) comprising:
a sounding reference signal (SRS) resource set indicator corresponding to a pair of SRS resource sets configured at the UE, the pair of SRS resource sets comprising a first SRS resource set for a first physical uplink shared channel (PUSCH) on a first antenna panel of the UE and a second SRS resource set for a second PUSCH on a second antenna panel of the UE, and
a pair of SRS resource indicators (SRIs);
matching each of the pair of SRIs to exclusively one of the first SRS resource set and the second SRS resource set based on the SRS resource set indicator;
building a first precoder for the first PUSCH using first precoder layers corresponding to first SRSs of the first SRS resource set identified by a first SRI of the pair of SRIs that is matched to the first SRS resource set;
building a second precoder for the second PUSCH using second precoder layers corresponding to second SRSs of the second SRS resource set identified by a second SRI of the pair of SRIs that is matched to the second SRS resource set; and
transmitting simultaneously the first PUSCH with the first antenna panel using the first precoder and the second PUSCH with the second antenna panel using the second precoder.

7. The method of claim 6, wherein a first number of precoder layers of the first precoder is different than a second number of precoder layers of the second precoder.

8. The method of claim 6, further comprising indicating, to the network, a first maximum rank for the first antenna panel and a second maximum rank for the second antenna panel; wherein:
a first rank of the first PUSCH is less than or equal to the first maximum rank; and
a second rank of the second PUSCH is less than or equal to the second maximum rank.

9. The method of claim 6, wherein a first bit field size for the first SRI is a function of a first total number of SRSs in the first SRS resource set and a first maximum rank for the first antenna panel.

10. The method of claim 9, wherein a second bit field size for the second SRI is a function of a second total number of SRSs in the second SRS resource set and a second maximum rank for the second antenna panel.

11. The method of claim 6, further comprising:
determining, based on the SRS resource set indicator, that demodulation reference signal (DMRS) ports used to transmit the first PUSCH may be from separate code division multiplexing (CDM) groups; and
transmitting the first PUSCH using a first DMRS port from a first CDM group and a second DMRS port from a second CDM group.

12. The method of claim 6, further comprising:
determining, based on the SRS resource set indicator, that demodulation reference signal (DMRS) ports used to transmit the first PUSCH may not be from separate code division multiplexing (CDM) groups; and
transmitting the first PUSCH using a plurality of DMRS ports from a same CDM group.

13. A method of a radio access network (RAN), comprising:
sending, to a user equipment (UE), downlink control information (DCI) comprising:
a pair of SRS resource indicators (SRIs); and
a sounding reference signal (SRS) resource set indicator corresponding to a pair of SRS resource sets configured at the UE, the pair of SRS resource sets comprising a first SRS resource set for a first physical uplink shared channel (PUSCH) on a first antenna panel of the UE and a second SRS resource set for a second PUSCH on a second antenna panel of the UE, the SRS resource set indicator indicating a matching of each of the pair of SRIs to exclusively one of the first SRS resource set and the second SRS resource set; and
receiving simultaneously the first PUSCH at a first transmission reception point (TRP) of the RAN and the second PUSCH at a second TRP of the RAN.

14. The method of claim 13, wherein the DCI further includes a first transmit precoder matrix indicator (TPMI) associated with a first SRI of the pair of SRIs that indicates a first number of layers and a second TPMI associated with a second SRI of the pair of SRIs that indicates a second number of layers.

15. The method of claim 13, wherein:
a first SRI of the pair of SRIs is configured to indicate a first number of precoder layers when applied with its matched one of the first SRS resource set and the second SRS resource set;
the second SRI of the pair of SRIs is configured to identify a second number of precoder layers when applied with its matched one of the first SRS resource set and the second SRS resource set; and
the first number of precoder layers is different than the second number of precoder layers.

16. The method of claim 13, further comprising receiving, from the UE, a first maximum rank for to the first antenna panel and a second maximum rank for the second antenna panel; and wherein:
a first rank of the first PUSCH is less than or equal to the first maximum rank; and
a second rank of the second PUSCH is less than or equal to the second maximum rank.

17. The method of claim 13, further comprising selecting the SRS resource set indicator to indicate whether demodulation reference signal (DMRS) ports used to transmit the first PUSCH may be from separate code division multiplexing (CDM) groups.

18-20. (canceled)
